(19) United States
(12) Patent Application Publication
(10) Pub. No.: US 2012/0195643 A1
(43) Pub. Date: Aug. 2, 2012

(54) IMAGE FORMING APPARATUS AND RECORDING MEDIUM

(75) Inventors: Minquan TIAN, Kanagawa (JP); Shinji HASEGAWA, Kanagawa (JP); Yuka ITO, Kanagawa (JP); Suguru NAKASO, Kanagawa (JP); Makoto FURUKI, Kanagawa (JP)

(73) Assignee: FUJI XEROX CO., LTD., Tokyo (JP)

(21) Appl. No.: 13/190,739

(22) Filed: Jul. 26, 2011

(30) Foreign Application Priority Data
Feb. 1, 2011 (JP) 2011-020082

(51) Int. Cl. G03G 15/01

(52) U.S. Cl. 399/223

(57) ABSTRACT

An image forming apparatus includes first and second image forming units. The first image forming unit forms a first image on a surface of a recording medium which has ratios of reflecting incident light. The second image forming unit forms a second image on the surface. The ratios of the recording medium are equal to or greater than a threshold value in all of a specular direction and a specific direction other than the specular direction. The first image has a ratio of reflecting the incident light in the specular direction being equal to or greater than the threshold value and a ratio of reflecting the incident light in the specific direction being less than the threshold value. The second image has the ratios of reflecting the incident light in the specular direction and in the specific direction being less than the threshold value.

### CROSS-REFERENCE TO RELATED APPLICATION

This application is based on and claims priority under 35 USC 119 from Japanese Patent Application No. 2011-020082 filed on Feb. 1, 2011.

### BACKGROUND

1. Technical Field

The invention relates to an image forming apparatus and a recording medium.

2. Related Art

Technologies using a glossiness gap of an image formed on a recording medium for transmitting information have been developed.

### SUMMARY

According to an aspect of the invention, an image forming apparatus includes a first image forming unit and a second image forming unit. The first image forming unit forms a first image on a surface of a recording medium that has ratios of reflecting incident light of a predetermined band. The second image forming unit forms a second image on the surface of the recording medium at another location that is different from a location where the first image is formed. The ratios of the recording medium are equal to or greater than a threshold value in all of a specular direction and a specific direction other than the specular direction. The first image has a ratio of reflecting the incident light in the specular direction being equal to or greater than the threshold value and a ratio of reflecting the incident light in the specific direction being less than the threshold value. The second image has the ratios of reflecting the incident light in the specular direction and in the specific direction being less than the threshold value.

### BRIEF DESCRIPTION OF THE DRAWINGS

Exemplary embodiments of the invention will be described in detail based on the following figures, wherein:

FIG. 1 is a diagram illustrating an overall configuration of an image forming apparatus according to an embodiment;

FIG. 2 is a diagram illustrating an example of a dot-shaped image;

FIG. 3 is a diagram illustrating a test for a preparation of toner;

FIGS. 4A and 4B are diagrams illustrating a strength ratio of reflected light to incident light; and

FIGS. 5A to 5C are diagrams illustrating an example of a recording medium on which an image is formed by the image forming apparatus.

### DETAILED DESCRIPTION

### 1. Embodiments

Hereinafter, embodiments of the invention will be described. In addition, terms used for describing the invention are defined as follows.

“Light” means electromagnetic waves including at least infrared rays in addition to visible rays.

“JIS standard P8142” means “Method of measuring 75 Degree Specular Glossiness of Paper and Board” defined by Japanese Industrial Standard.

1-1. Overall Configuration of Image Forming Apparatus

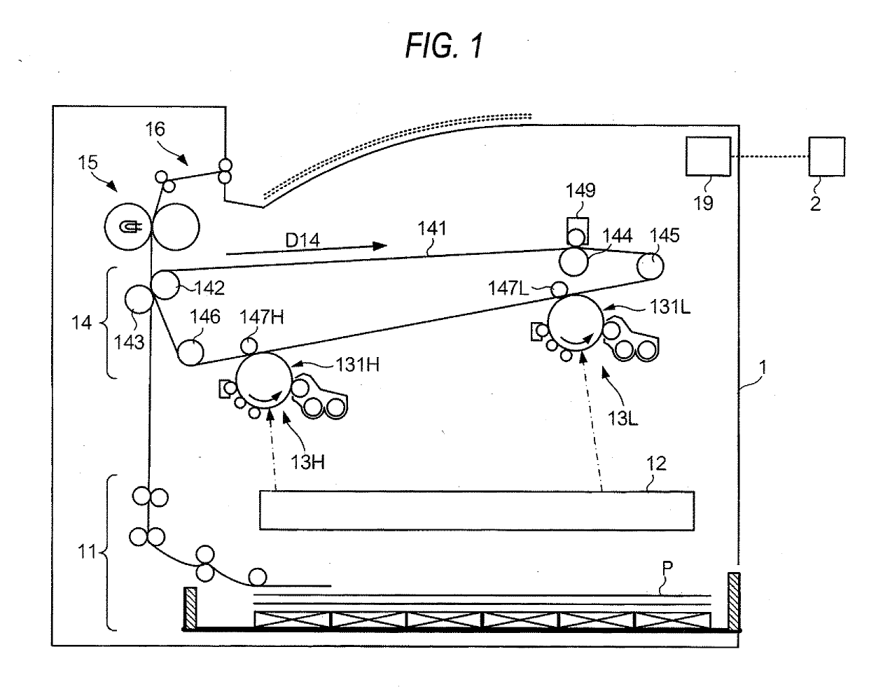

FIG. 1 shows a diagram illustrating an overall configuration of an image forming apparatus according to this embodiment. As shown in FIG. 1, the image forming apparatus 1 includes a feeding section 11, an optical scanning section 12, developing sections 13H and 13L, a transfer section 14, a fixing section 15, a discharge section 16, and a control section 19. The feeding section 11, the optical scanning section 12, the developing sections 13H and 13L, the transfer section 14, the fixing section 15, and the discharge section 16 are controlled by the control section 19. In addition, a letter H attached at the end of reference numeral means a configuration corresponding to a highly glossy toner having a high glossiness, a letter L means a configuration corresponding to a low glossy toner having a glossiness lower than that of the highly glossy toner. In regard to the developing sections 13H and 13L, kinds of toner used are different, and configurations thereof are not largely different from each other. Hereinafter, in a case where it is not necessary to particularly classify the highly glossy toner and the low glossy toner, they are simply called toner. In addition, in a case where it is not necessary to particularly classify the developing sections 13H and 13L, the letters representing a kind of toner are omitted, and they are called “developing sections 13”. Details of the toner will be described later. The toner is mixed with carrier and a charge is applied thereto from the carrier. The mixture of the toner and carrier is supplied to the developing section 13 as a developer.

The feeding section 11 stores sheets P as a recording medium that is cut to a predetermined size. The sheets P stored in the feeding section 11 are taken out one by one according to indication of the control section 19 and conveyed to the transfer section 14 through a sheet conveying path. In addition, the recording medium is not particularly limited, but for example, a resin sheet or the like may be used.

The control section 19 stores respective image data for each toner in correlation with each other in a RAM (Random Access Memory) or the like. The optical scanning section 12 includes an irradiation device that generates light beams corresponding to each image data, respectively, and irradiates the corresponding developing sections 13H and 13L with the generated light beams under the control of the control section 19.

The image data correlated with each toner shows information by an arrangement pattern obtained by arranging dot-shaped images in a lattice shape. Details of the dot-shaped image and the arrangement thereof will be described later.

The transfer section 14 includes an intermediate transfer belt 141, a belt conveying roller 142, a secondary transfer roller 143, a cleaner back up roller 144, a steering roller 145, a tension roller 146, primary transfer rollers 147H and 147L (hereinafter, if it is not necessary to particularly classify them, they are collectively referred as primary transfer rollers 147), and a belt cleaner 149, and transfers an image formed by the developing section 13 onto the sheet P. The intermediate transfer belt 141 is an endless strip-shaped member that circularly moves, and is stretched by the belt conveying roller 142, the cleaning backup roller 144, the steering roller 145, the tension roller 146, and the primary transfer rollers 147.

A driving unit (not shown) such as a motor is connected to the belt conveying roller 142 through a gear or the like, and makes the intermediate transfer belt 141 circularly move in a direction of an arrow D14 in FIG. 1. In addition, another roller not connected to the driving unit rotates according to a circular movement of the intermediate transfer belt 141. When the intermediate transfer belt 141 is circularly moved in the direction of the arrow D14 in FIG. 1 and is rotated, the image transferred by the transfer section 14 is moved to a region where the belt conveying roller 142 and the secondary transfer roller 143 come into contact. The secondary transfer roller 143 is provided at a location facing the belt conveying roller 142 at an external side of the intermediate transfer belt 141, and supports the intermediate transfer belt 141 together with the belt conveying roller 142 with the intermediate transfer belt 141 interposed therebetween. For example, the secondary transfer roller 143 is grounded, such that a predetermined potential thereof is maintained.

The belt conveying roller 142 presses the intermediate transfer belt 141 at a portion brought into contact with the belt conveying roller 142 from an internal side toward an external side, and electrifies the portion with the same polarity as that of the toner. In this manner, a predetermined potential difference occurs between the contact portion of the intermediate transfer belt 141 and the secondary transfer roller 143, such that due to this potential difference, the image on the intermediate transfer belt 141 is transferred onto the sheet P conveyed from the feeding section 11.

The belt cleaner 149 removes un-transferred toner remaining on a surface of the intermediate transfer belt 141. The cleaner backup roller 144 supports the intermediate transfer belt 141 from the internal side at a location facing the belt cleaner 149 and assists the cleaning of the toner by the belt cleaner 149.

The tension roller 146 supports the intermediate transfer belt 141 from the primary transfer roller 147H to the belt conveying roller 142 from the internal side. The transfer section 14 conveys the sheet P on which the image is transferred to the fixing section 15.

Each of the developing sections 13 includes a photosensitive drum 131 as an example of an image carrying body that carries an image. Each photosensitive drum 131 carries a latent image corresponding to light emitted from the light scanning section 12. Each of the developing sections 13 forms an image indicated by image data correlated with each toner from the latent image maintained by the photosensitive drum 131 by using the corresponding toner. Specifically, a surface of the photosensitive drum 131 is electrified with the same polarity as that of the toner, and the surface is irradiated with light by the optical scanning section 12 and the toner is adhered to a portion where a charge is lost, and thereby the developing sections 13 form an image.

As described above, in regard to the inner side of the intermediate transfer belt 141, each of the primary transfer rollers 147 is provided at a portion facing each of the photosensitive drums 131. The primary transfer roller 147 presses a portion of the intermediate transfer belt 141 that is brought into contact with the primary transfer roller 147 from the internal side toward the external side, and electrifies the contact portion with a polarity opposite to that of the toner. In this manner, a potential difference occurs between the contact portion of the intermediate transfer belt 141 and the photosensitive drum 131 facing the primary transfer roller 147, and thereby an image is transferred onto the intermediate transfer belt 141.

After the image is transferred, the surface of the photosensitive drum 131 is neutralized by the cleaner, and the remaining un-transferred toner is removed.

The fixing section 15 includes a heating roller and a pressing roller and performs heating and pressing processes using them, and thereby fixes the image transferred onto the sheet P to the sheet P. The discharge section 16 discharges the sheet P that has undergone the fixing process performed by the fixing section 15 to a sheet stack location provided at an upper portion of the image forming apparatus 1. The control section 19 controls each component of the image forming apparatus 1 such as the developing section 13 according to an instruction signal received from an external apparatus 2 that is communicably connected, a user operation using an operation unit (not shown), or the like, and forms an image on the sheet P.

1-2. Dot-Shaped Image

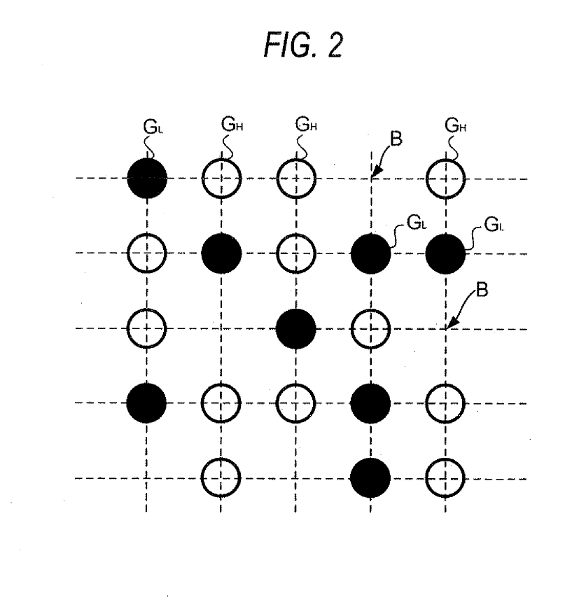

FIG. 2 shows a diagram illustrating an example of dot-shaped images. As shown in FIG. 2, dot-shaped images made by the toner are arranged in a lattice shape on the sheet P, and thereby an image showing information corresponding to such an arrangement pattern is formed. At a location at which the image is arranged, the highly glossy toner by the developing section 13H or the low glossy toner by the developing section 13L is applied as a circular dot, that is, a dot-shaped image. In addition, these dot-shaped images are not arranged in a lattice shape without a gap, and there is a location where any one of the highly glossy toner and the low glossy toner is not arranged. Hereinafter, as shown in FIG. 2, a dot-shaped image made by the highly glossy toner is referred to as a dot-shaped image G_{H}, a dot-shaped image made by the low glossy toner is referred to as a dot-shaped image G_{L}, and a blank area where any one of the highly glossy toner and the low glossy toner is not arranged is referred to as a blank area B. By an arrangement of each of the dot-shaped image G_{H} and the dot-shaped image G_{L}, images showing two kinds of information, respectively, are formed on the sheet P.

1-3. Developer

1-3-1. Carrier

The developer is a so-called two-component developer including toner and carrier. The carrier that can be used in the two-component developer is not particularly limited, and commonly known carrier may be used. For example, magnetic metal such as iron oxide, nickel, and cobalt, magnetic oxide such as ferrite and magnetite, resin-coated carrier having a resin coating layer on a surface of a core thereof, a magnetic dispersion type carrier, or the like may be exemplified. In addition, resin dispersion carrier in which a conductive material is dispersed in a matrix resin may be used.

1-3-2. Toner

Toner includes pigment and resin, and is formed by dispersing the pigment in the resin. The pigment absorbs light of a predetermined band and decreases the strength of the light of the band included in reflected light. The resin holds the pigment by dispersing it therein, and becomes a factor that determines the glossiness at an applied surface. In addition, as the recording medium such as the sheet P, a recording medium in which a ratio of reflecting the light of the above-described band is equal to or greater than a predetermined threshold value V₁ may be used. The threshold value V₁ is determined according to a value that is compared with the strength of the reflected light when determining whether an image is present or not by a light receiving sensor. That is, the sheet P is an example of the recording medium in which the ratio of reflecting incident light of the predetermined band is equal to or greater than the threshold value.

(1) Pigment

The pigment contained in the toner includes, for example, an infrared-ray-absorbing agent that absorbs an infrared ray of a 750-1000 nm band as light of a predetermined band. The pigment contains, for example, perimidine-based squarylium dye expressed by the following formula (I) as the infrared-ray-absorbing agent.

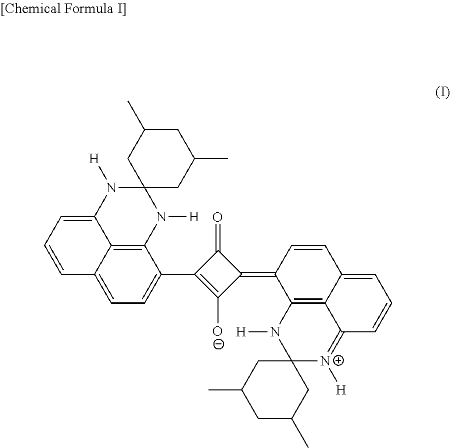

(2) Resin

In regard to the highly glossy toner and the low glossy toner, the resin in which the pigment is dispersed is different. Hereinafter, the resin for the highly glossy toner included in the highly glossy toner and the resin for the low glossy toner included in the low glossy toner will be described, respectively.

Both of the resin for the highly glossy toner and the resin for the low glossy toner include at least thermoplastic binder resin. As the binder resin, for example, commonly known resin such as a polyester-based resin, a polystyrene-based resin, a polyacryl-based resin, a vinyl-based resin, a polycarbonate-based resin, a polyamide-based resin, a polyimide-based resin, an epoxy-based resin, and a polyurea-based resin, and copolymers thereof may be exemplified. Among these, the polystyrene-based resin is preferable from the viewpoint of concurrently satisfying characteristics of the toner such as an adhesion property with a sheet, a low-temperature fixing property, a fixing strength, and a preserving property. In addition, it is preferable that the binder resin has a weight-average molecular weight of 5000 to 40000, and a glass transition temperature equal to or greater than 55° C. and less than 75° C.

In addition, the resin may include an inorganic powder for the purpose of adjusting a viscoelasticity. The inorganic powder may be a powder used as an external additive of the toner surface. More particularly, for example, silica, alumina, titan oxide, barium titanate, magnesium titanate, calcium titanate, strontium titanate, zinc oxide, silica sand, clay, mica, wollastonite, diatomite, cerium chloride, colcothar, chrome oxide, cerium oxide, antimony trioxide, magnesium oxide, zirconium oxide, silicon carbide, silicon nitride, or the like may be exemplified. These inorganic particles are generally used for the purpose of improving flowability. In the highly glossy toner resin, the amount of the above-described inorganic powder is adjusted so that the viscoelasticity of the highly glossy toner resin is less than that of the low glossy toner resin. This is because as the viscoelasticity decreases, the glossiness at the applied surface increases.

(3) Test for Toner Preparation

The amount of the inorganic powder added for the preparation of the toner is determined to satisfy the following test.

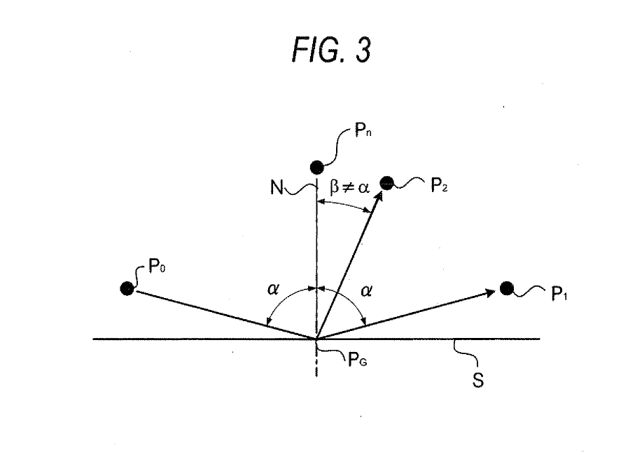

FIG. 3 shows a diagram illustrating the test for the preparation of the toner. This test is for measuring the glossiness at a point P_{G} that is one point on a surface S of the recording medium. In FIG. 3, a light source P₀ emits the infrared ray absorbed by the above-described pigment toward the point P_{G} on the surface S with an incident angle α. A first light receiving sensor having a light receiving point P₁ is provided at a location that is line-symmetric with a light source P₀ with a normal line N of the surface S passing the point P_{G} interposed therebetween. That is, the light receiving point P₁ is on a line extending in a direction (hereinafter, referred to as a specular direction) where a reflection angle of the infrared ray emitted from the light source P₀ becomes equal to the incident angle α. In addition, a second light receiving sensor having a light receiving point P₂ is provided in a reflection direction where the reflection angle is that is different from the incident angle α. In addition, in regard to a readout device such as a general scanner, in a case where light such as an infrared ray is emitted toward a point P_{G} on the surface S from the light source P₀ with an incident angle that is not zero (that is, α≠0) for excluding an effect of the specular reflection, cases where a light receiving sensor is provided at a point Pₙ on the normal line N of the surface S passing the point P_{G} to detect the reflected light occur frequently. In this case, since β=0, that is α≠β, the point Pₙ is an example of the light receiving point P₂ that is located in a reflection direction where the reflection angle β is different from the incident angle α.

The first and second light receiving sensors detect the reflected light that is reflected from a given location on the surface S of the recording medium and measure a ratio of the reflected light to the incident light. In a case where the ratio is equal to or greater than a predetermined threshold value V₁, the sensors determine that there is no image at the location, and in a case where the ratio is less than the threshold value V₁, the sensors determine that there is an image at the location.

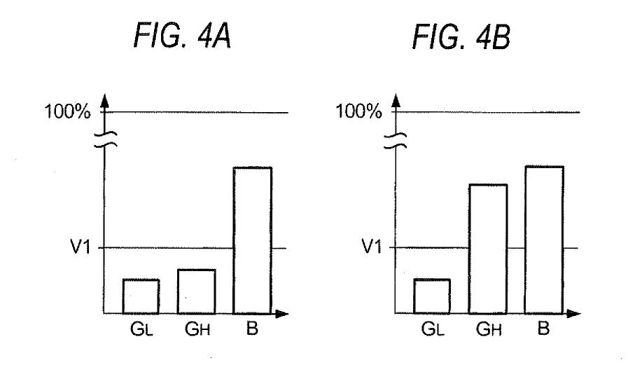

FIGS. 4A and 4B show diagrams illustrating a strength ratio of the reflected light detected by each of the light receiving sensors to the incident light emitted from the light source P₀. The second light receiving sensor having the light receiving point P₂ detects the infrared ray reflected in a specific direction that is a direction different from the specular direction, and measures a ratio of the infrared ray that is emitted from the light source P₀ and is reflected in the specific direction. The reflection ratio in the specific direction is shown in FIG. 4A, and the ratio at a blank area B is equal to or greater than the threshold value V₁. On the contrary, the ratio in each of the dot-shaped image G_{H} and the dot-shaped image G_{L} is less than the threshold value V₁.

On the other hand, the first light receiving sensor having the light receiving point P₁ is provided in a specular direction with respect to the incident light (infrared ray) emitted from the light source P₀, and measures the ratio of reflecting the incident light in the specular direction. The ratio of reflecting the incident light in the specular direction is shown in FIG. 4B, and the ratio in each of the blank area 13 and the dot-shaped image G_{H} is equal to or greater than the threshold value V₁. On the contrary, the ratio in the dot-shaped image G_{L} is less than the threshold value V₁.

The highly glossy toner and the low glossy toner are prepared in such a manner that the dot-shaped image G_{H} and the dot-shaped image G_{L} satisfy the above described conditions. For this reason, for example, the inorganic powder is added to the resin for the highly glossy toner in an amount more than that in the resin for the low glossy toner.

In addition, the control section 19, the feeding section 11, the optical scanning section 12, the transfer section 14, and the fixing section 15, and the developing section 13H form the dot-shaped image G_{H} on a surface of the sheet P by the highly glossy toner, which is a first image in which the ratio of reflecting the incident light of the infrared ray in the specular direction is equal to or greater than the threshold value and the reflection ratio in the specific direction is less than the threshold value, such that this configuration is an example of “first image forming means for forming the first image in which the ratio of reflecting the incident light in the specular direction is equal to or greater than the threshold value and the reflection ratio in the specific direction other than the specular direction is less than the threshold value, on a surface of the recording medium in which the ratio of reflecting incident light of a predetermined band is equal to or greater than the threshold value.” The highly glossy toner is an example of “a first image forming material in which the ratio of reflecting the incident light of a predetermined band is equal to or greater than the threshold value, and the ratio of reflecting the incident light in the specific direction other than the specular direction is less than the threshold value, after forming the image.”

In addition, the control section 19, the feeding section 11, the optical scanning section 12, the transfer section 14, and the fixing section 15, and the developing section 13L form a second image in which the ratios of reflecting the incident light of the infrared ray in the specular direction and the specific direction are less than the threshold value by the low glossy toner on the surface of the sheet P at a location different from the location where the dot-shaped image G_{H} is formed, such that this configuration is an example of “second image forming means for forming the second image in which the ratios of reflecting the incident light in the specular direction and the specific direction are less than the threshold value by the low glossy toner on the surface of the recording medium at a location different from the location where the first image is formed.” The low glossy toner is an example of “a second image forming material in which the ratios of reflecting the incident light of a predetermined band in the specular direction and the specific direction are less than the threshold value, after forming the image.”

1.4 Recording Medium

Description will be given to the recording medium on which the image of the image data correlated with each toner is formed by the image forming apparatus 1 using each toner prepared as described above.

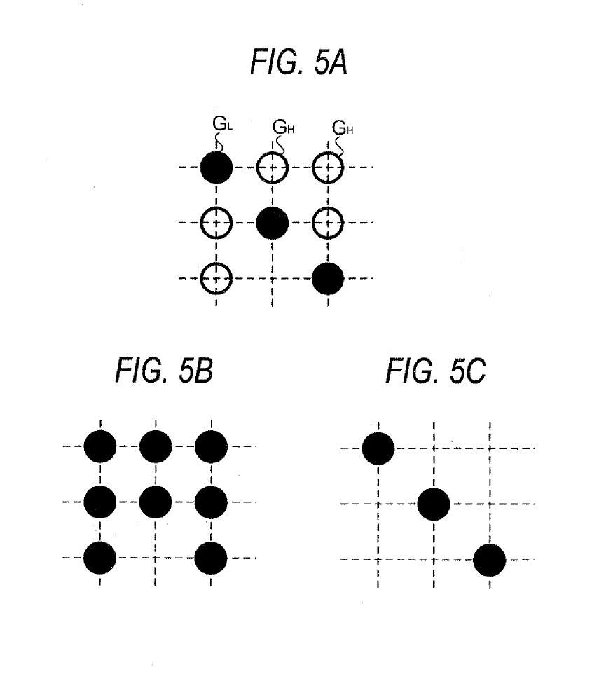

FIGS. 5A to 5C are diagrams illustrating an example of a recording medium on which an image is formed by the image forming apparatus 1. For example, as shown in FIG. 5A, among nine intersected points made up by three vertical lines and three horizontal lines, the dot-shaped image G_{H} is formed at each of five positions, the dot-shaped image G_{L} is fixated at each of three locations, and a location besides the above-described locations becomes a blank area B where neither the dot-shaped image G_{H} nor the dot-shaped image G_{L} is formed. At this time, when the above-described second light receiving sensor discriminately detects an area where the ratio of reflecting the incident light in the specific direction is less than the threshold value V₁ and an area where the ratio is equal to or greater than the threshold value V₁, the blank area B and the dot-shaped image G_{H} and the blank area B and the dot-shaped image G_{L} are discriminated, respectively, but the dot-shaped image G_{H} and the dot-shaped image G_{L} are not discriminated. Therefore, in this case, since the second light receiving sensor does not discriminate the image shown in FIG. 5A and an image shown in FIG. 5B where all of the dot-shaped images G_{H} of the image are substituted with the dot-shaped image G_{L}, it is impossible to obtain an image shown by only the dot-shaped image G_{L}.

On the other hand, when the above-described first light receiving sensor discriminately detects an area where the ratio of reflecting the incident light in the specular direction is less than the threshold value V₁ and an area where the ratio is equal to or greater than the threshold value V₁, the blank area B and the dot-shaped image G_{H} are not discriminated, however the dot-shaped image G_{H} and the dot-shaped image G_{L} are discriminated. Therefore, in this case, since the first light receiving sensor does not discriminate the image shown in FIG. 5A and an image shown in FIG. 5C where all of the dot-shaped images G_{H} of the image are substituted with the blank area B, that is, the image where only the dot-shaped image G_{L} is arranged is not discriminated, an image shown by only the dot-shaped image G_{L} is obtained.

For example, as the second light receiving sensor, a scanner including a light receiving section at a location not receiving the light reflected in the specular direction may be exemplified. Since the scanner is provided in a manner that does not receive light that is reflected in the specular direction, for example, a sensor is provided in a specific direction other than the specular direction and detects the light reflected in the specific direction. Therefore, the scanner does not discriminate the dot-shaped image G_{H} and the dot-shaped image G_{L} and it is impossible to obtain an image shown by only the dot-shaped image G_{L}. Therefore, according to the image forming apparatus 1, the duplication of image information by a scanner or a copying machine is restricted.

On the other hand, as the first light receiving sensor, a pen-shaped device that freely changes an angle for receiving light from the recording medium may be exemplified. The pen-shaped device may be a device that reads out a pattern of dot-shaped images arranged on the recording medium, matches it with a predetermined pattern, and specifies information indicating a location of the readout portion on the recording medium. In this case, an angle of the readout section is adjusted by the pen-shaped device in such a manner that the reflected light reflected in the specular direction from a surface of the recording medium is received, and when the readout section is moved on the surface along it and draws a character, a figure, or the like (hereinafter, referred to as a character or the like), a shape of the character, a location of the character, or the like on the recording medium are specified. Accordingly, the pen-shaped device stores the drawn character or the like as digital information.

Hereinbefore, as described above, in the case of detecting the reflected light in the specific direction other than the specular direction, when the two dot-shaped images G_{H} and G_{L} are not discriminated, the image shown by the dot-shaped image G_{H} blocks out the image shown by only the dot-shaped image G_{L}. On the other hand, in the case of detecting the light reflected in the specular direction, since the ratio of reflecting the incident light in the specular direction by the gloss of the dot-shaped image G_{H} is equal to or greater than the threshold value, the image formed by the dot-shaped image G_{H} and the blank area are not discriminated. That is, since the two dot-shaped image G_{H} and G_{L} are discriminated, the image shown by only the dot-shaped image G_{L} is revealed. As described above, according to the image forming apparatus 1, it is possible to overlap two kinds of images, which can be read out by simply changing a readout angle at the time of reading out, on the recording medium without performing a separate heat treatment like in JP-A-2009-015208, for example.

### 2. Modifications

Hereinbefore, an embodiment is described, however the contents of this embodiment may be modified as described below. In addition, the following modifications may be combined.

2-1. Modification 1

In the above-described embodiment, the pigment contains, for example, the permidine-based squarylium dye expressed by formula (1), but may contain other infrared-ray-absorbing agents. In addition, the pigment contains the infrared-ray-absorbing agent that absorbs the infrared ray as light of a predetermined band, but may contain an absorbing agent that absorbs light of a band other than the infrared ray. That is, the pigment may be one that absorbs the infrared ray or one that absorbs light of a band other than the infrared ray without absorbing the infrared ray. In conclusion, as the pigment, other material may be used as long as it absorbs light of a predetermined band.

2-2. Modification 2

In the above-described embodiment, the amount of the inorganic powder added to each toner is determined in such a manner that a test for the preparation of toner is satisfied, but a test of JIS standard P8142 may be performed instead of the above-described test. In this case, it is preferable that the highly glossy toner have 75 degree specular glossiness of 25 or more at an area arranged on the recording medium, and the low glossy toner have 75 degree specular glossiness less than 20 at an area arranged on the recording medium, based on JIS standard P8142.

2-3. Modification 3

In the above-described embodiment, in the image forming apparatus 1, the developing section 13L is provided at an upstream side in the circulating direction of the intermediate transfer belt 141 and the developing section 13H is provided at a downstream side, however the dispositions of the developing sections 13 may be inverse to each other.

In addition, in the above-described embodiment, the image forming apparatus 1 includes two developing sections 13, but three or more of developing sections 13 may be provided. In this case, each of the developing sections 13 may form an image on the photosensitive drum 131 by using different toner, respectively.

For example, in a case where three developing sections 13 are provided, it may be configured in such a manner that a developing section 13M using an intermediately glossy toner whose glossiness is lower than that of the highly glossy toner and is higher than that of the low glossy toner is provided in addition to the developing section 13H using the highly glossy toner and the developing section 13L using the low glossy toner.

In this case, in each of a dot-shaped image G_{H} formed with the highly glossy toner, a dot-shaped image G_{L} formed with the low glossy toner, and a dot-shaped image G_{M} formed with the intermediately glossy toner, a ratio of reflecting the incident light in a specific direction, which is measured by the second light receiving sensor, is less than the threshold value V₁, such that these three kinds of dot-shaped images are not discriminated by the second light receiving sensor. On the other hand, when the amount of the inorganic powder added to each toner resin is adjusted in such a manner that in regard to a ratio of reflecting the incident light in the specular direction, the dot-shaped image G_{L} is less than the threshold value V₁, the dot-shaped image G_{M} is equal to or greater than V₁ and less than a threshold value V₂ (V₁<V₂), and the dot-shaped image G_{H} is equal to or greater than V₂ and less than V₃ (V₂<V₃), the first light receiving sensor discriminates the ratio of reflecting the incident light in the specular direction through the comparison with the threshold values V₁, V₂, and V₃, and thereby the dot-shaped images G_{L}, G_{M}, G_{H} are discriminated. Therefore, the first light receiving sensor obtains an image of image data correlated with each toner, respectively.

In addition, in this case, when the dot-shaped image G_{L} and the dot-shaped image G_{M} are discriminated, the dot-shaped image G_{M} and the dot-shaped image G_{H} may not be discriminated. In addition, the dot-shaped image G_{M} and the dot-shaped image G_{H} are discriminated, the dot-shaped image G_{M} and dot-shaped image G_{L} may not be discriminated. In conclusion, among plural kinds of dot-shaped images formed by toner whose glossiness is discriminated in a plurality of levels, respectively, two kinds or more may be discriminable.

Further, in addition to these developing sections 13, a developing section that forms an image made by separate toner containing different pigment may be provided in a circle around the intermediate transfer belt 141. For example, in a case where a developing section including pigment such as cyan, magenta, yellow, and black that has an absorption band corresponding to visible light (for example, light with a wavelength of 400 to 700 nm) is provided in addition to the developing sections 13H and 13L, a visible image that is visible to humans is formed on the recording medium in addition to an invisible image that is detected by the light receiving sensor.

2-4. Modification 4

In the above-described embodiment, the dot-shaped image G_{H} formed with the highly glossy toner has a ratio of reflecting the incident light in the specular direction, which is equal to or greater than the threshold value V₁, and is less than that in the blank area B, however the dot-shaped image G_{H} may have the ratio of reflecting the incident light in the specular direction, which is higher than that of the blank area B.

In addition, the threshold value V₁ is determined to be lower than the ratio of reflecting the incident light in the specular direction in the blank area B, but may be determined with the blank area given as a reference. In this case, the dot-shaped image G_{H} has the ratio of reflecting the incident light in the specular direction, which is equal to or greater than that of the blank area B, and the ratio of reflecting the incident light in the specific direction, which is less than that of the blank area B. The dot-shaped image G_{L} has the ratio of reflecting the incident light in the specular direction and the specific direction, which is smaller than that of the blank area B.

In this case, the highly glossy toner is an example of “a first image forming material in which the ratio of reflecting the incident light of a predetermined band is equal to or greater than the threshold value, and the ratio of reflecting the incident light in the specific direction other than the specular direction is less than the threshold value in the recording medium after forming the image.”

The low glossy toner is an example of “a second image forming material in which the ratios of reflecting the incident light in the specular direction and the specific direction are less than the threshold value in the recording medium after forming the image.”

2-5. Modification 5

In the above-described embodiment, the dot-shaped image is a circular dot, but the shape of the dot is not limited to a circular shape, and for example, may be a rectangular shape.

In addition, in the above-described embodiment, in the case of drawing virtual vertical lines and virtual horizontal lines, the dot-shaped images are arranged at intersected points, but the dot-shaped images may be arranged at locations deviated from the intersected points. An amount of the deviation and a direction are determined for each of the dot-shaped images, and the amount of the deviation from the corresponding intersected point in each of the dot-shaped images and the direction of the deviation are combined, and thereby information may be shown. In addition, an interval of the lattice may adopt various values, but for example, in a case where the recording medium is A4 size (210 mm×297 mm) defined in ISO 216, when the interval of the lattice is set to substantially 0.3 mm, the number of the arrangement patterns is desirable to be sufficient for specifying the location on the recording medium.

2-6. Modification 6

In the above-described embodiment, a plurality of dot-shaped images are arranged on the sheet P in a matrix shape, and an image showing information corresponding to the arrangement pattern is formed, but the image formed on the sheet P is not limited to the dot-shaped image. For example, in the manner of a one-dimensional bar code, line segments having plural kinds of sizes are arranged in parallel, and thereby an image showing information according to the arrangement pattern may be formed.

In addition, instead of forming an image showing specific information according to a plurality of arrangement patterns, an image showing the specific information by a shape or a size of an image formed in one connected area may be formed. For example, when the highly glossy toner is applied and fixed on one line, which vertically extends in the reading direction of the sheet P, as one connected area in the surface of the sheet P fed by the feeding section 11, by the developing section 13H, the transfer section 14, and the fixing section 15, the one line is formed as a first image made by the highly glossy toner. In addition, when the low glossy toner is applied and fixed on two rectangles adjacent to the above-described one line at the left and right sides thereof, as areas other than the connected area in the surface of the sheet P fed by the feeding section 11, by the developing section 13L, the transfer section 14, and the fixing section 15, the two rectangles are formed as a second image made by the low glossy toner. In this case, a ratio of reflecting incident light, which is incident onto a surface of the sheet P, in a specific direction is less than the threshold value in both of the first image and the second image, such that the second light receiving sensor disposed in a specific direction does not detect the second image with the first and second images discriminated. On the other hand, a ratio of reflecting the incident light, which is incident onto the surface of the sheet P, in a specular direction is less than the threshold value in the second image, but is equal to or greater than the threshold value in the first image. Therefore, the first light receiving sensor provided in the specular direction detects the second image with the first and second images discriminated.

2-7. Modification 7

In the above-described embodiment, since the reflected light ratio of reflecting the incident light in the specular direction by the dot-shaped image G_{H} exceeds the threshold value V₁, the dot-shaped image G_{H} and the dot-shaped image G_{L} are discriminated by the light receiving sensor provided in the specular direction, and the image shown by only the dot-shaped image G_{L} is recognized. That is, with respect to the light receiving sensor provided in the specific direction other than the specular direction, there is an effect of blocking out the image formed with the low glossy toner by the image formed with the highly glossy toner. However, an image formed with the highly glossy toner may be added to the image that is not completed by only the image formed with the low glossy toner, and thereby the completed image may be read out by the readout device. In this case, an object image is not read out by the light receiving sensor that detects the reflected light in the specular direction, but the object image is read out by the light receiving sensor that detects the reflected light that is reflected in the specific direction other than the specular direction.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An image forming apparatus comprising:
a first image forming unit that forms a first image on a surface of a recording medium which has ratios of reflecting incident light of a predetermined band; and
a second image forming unit that forms a second image on the surface of the recording medium at another location which is different from a location where the first image is formed,
wherein the ratios of the recording medium are equal to or greater than a threshold value in all of a specular direction and a specific direction other than the specular direction,
the first image has a ratio of reflecting the incident light in the specular direction being equal to or greater than the threshold value and a ratio of reflecting the incident light in the specific direction being less than the threshold value, and
the second image has the ratios of reflecting the incident light in the specular direction and in the specific direction being less than the threshold value.

2. The image forming apparatus according to claim 1,
wherein the ratio of reflecting the incident light in the specular direction of the first image is equal to or greater than that of the recording medium, and the ratio of reflecting the incident light in the specific direction of the first image is less than that of the recording medium, and
the ratio of reflecting the incident light in the specular direction of the second image is less than that of the recording medium, and the ratio of the reflecting the incident light in the specific direction of the second image is less than that of the recording medium.

3. The image forming apparatus according to claim 1,
wherein the incident light is an infrared ray.

4. The image forming apparatus according to claim 1,
wherein 75 degree specular glossiness based on JIS standard P8142 is 25 or more in the first image, and
the 75 degree specular glossiness is less than 20 in the second image.

5. A recording medium comprising:
a surface that has ratios of reflecting incident light of a predetermined band and that has first and second images which are formed on the surface, the second image being at another location which is different from a location where the first image is formed,
wherein the ratios of the recording medium are equal to or greater than a threshold value in all of a specular direction and a specific direction other than the specular direction,
the first image has a ratio of reflecting the incident light in the specular direction being equal to or greater than the threshold value and a ratio of reflecting the incident light in the specific direction being less than the threshold value, and
the second image has the ratios of reflecting the incident light in the specular direction and in the specific direction being less than the threshold value.
